(19) United States
(12) Patent Application Publication
(10) Pub. No.: US 2009/0288737 A1
(43) Pub. Date: Nov. 26, 2009

(54) Apparatus for positioning and splitting wood

(76) Inventor: Mathew A. Gilmet, Midland, MI (US)

Correspondence Address: Timothy S. Stevens, Patent Attorney, 5108 Foxpoint Circle, Midland, MI, 48642, US

(21) Appl. No.: 12/154,622

(22) Filed: May 23, 2008

(51) Int. Cl. B27L 7/00

(52) U.S. Cl. 144/195.1

(57) ABSTRACT

Apparatus for positioning and splitting wood. The apparatus includes: a beam having a longitudinal axis; a wood splitting blade attached at or near an of the beam; a workpiece slidably attached to the beam such that when wood is positioned between the splitting blade and the workpiece and the workpiece is slid in the direction of the longitudinal axis of the beam toward the splitting blade, the wood is forced into the splitting blade to split the wood; and a stationary jaw member attached at or near one end of the beam so that when the apparatus is attached to the boom of a backhoe or the like in place of the bucket thereof, wood can be grasped between the stationary jaw member and a jaw member attached to the boom of the backhoe or the like so that the wood can be positioned by movement of the apparatus.

### BACKGROUND OF THE INVENTION

The instant invention is in the field of wood splitters and more specifically the instant invention is in the field of wood splitters that have the additional capability to move and position wood to be split.

In the logging and tree service industry many tools have been developed to make it easier to process wood once the trees have been trimmed or cut down. In particular, attempts have been made to provide improved wood splitting devices. For example, the well known trailer mounted hydraulic wood splitting devices (such as the device described in U.S. Pat. No. 4,310,039) were a significant improvement. However, such devices did not address the problem of moving wood to the splitter or moving the split wood to, for example, the bed of a truck. A number of devices have been disclosed that can be used to both position and split wood. The devices disclosed in US 2003/0155037 and U.S. Pat. No. 6,609,547 comprises a hydraulic wood splitter suspended from a beam mounted to a skid steer loader. U.S. Pat. No. 4,559,985 describes a hydraulic wood splitter suspended from a beam suspended from a rotatable boom. U.S. Pat. No. 5,803,141 describes a hydraulic wood splitter suspended from a rotatable beam, which beam is attached to an arm assembly attached to a support vehicle.

A number of wood splitting and moving devices have been attached to the boom of a backhoe or excavator and the like. U.S. Pat. No. 4,615,367 describes a backhoe log splitter having a stationary splitting blade and a pivoting log pushing system. U.S. Pat. No. 5,320,149 describes a backhoe log splitter having a pivoting splitting blade and a pivoting claw to grip wood between the splitting blade and the claw.

Despite the many improvements that have been made in the art of wood splitting devices, there remains a need for a wood splitting apparatus that is easily and reversibly coupled to a backhoe boom or the like, which is more readily observed in operation and which permits an improved means of moving wood before and after splitting.

### SUMMARY OF THE INVENTION

The instant invention provides an apparatus that is easily and reversibly coupled to a backhoe boom or the like in place of the bucket thereof, which apparatus is more readily observed in operation and which apparatus permits an improved means of moving wood before and after splitting, and which is capable of moving not only wood but branches and brush to, for example, brush chipper. More specifically, the instant invention is an apparatus for positioning and splitting wood, comprising: a beam having a first end and a second end, the beam having a longitudinal axis; a wood splitting blade attached at or near the first end of the beam; a workpiece slidably attached to the beam such that when wood is positioned between the splitting blade and the workpiece and the workpiece is slid in the direction of the longitudinal axis of the beam toward the splitting blade, the wood is forced into the splitting blade to split the wood; and a stationary jaw member attached at or near the second end of the beam so that when the apparatus is attached to the boom of a backhoe or excavator in place of the bucket thereof, wood can be grasped between the stationary jaw member and a jaw member attached to the boom of the backhoe or excavator so that the wood can be positioned by movement of the apparatus.

In an alternative embodiment, the instant invention is an apparatus for positioning and splitting wood, comprising: a beam having a first end and a second end, the beam having a longitudinal axis; a wood splitting blade attached at or near the second end of the beam; a workpiece slidably attached to the beam such that when wood is positioned between the splitting blade and the workpiece and the workpiece is slid in the direction of the longitudinal axis of the beam toward the splitting blade, the wood is forced into the splitting blade to split the wood; and a stationary jaw member attached at or near the second end of the beam so that when the apparatus is attached to the boom of a backhoe or excavator in place of the bucket thereof, wood can be grasped between the stationary jaw member and a jaw member attached to the boom of the backhoe or excavator so that the wood can be positioned by movement of the apparatus.

### BRIEF DESCRIPTION OF THE DRAWINGS

FIG. 1 is a perspective view of a broken away portion of the bucket end of the boom of an excavator positioned over a quick coupler which is, in turn positioned over a preferred apparatus of the instant invention;

FIG. 2 is a perspective view of a preferred apparatus of the instant invention attached to the boom of an excavator in place of the bucket thereof by way of a quick coupler;

FIG. 3 is a perspective view of a broken away portion of the bucket end of the boom of an excavator attached to a quick coupler which is attached to a preferred apparatus of the instant invention;

FIG. 4 is a perspective view of an alternative embodiment of the instant invention wherein the beam is an I-beam and wherein the position of the wood splitting blade is reversed;

FIG. 5 is a side view of the bucket end of the boom of an excavator having a stationary jaw member attached thereto; and

FIG. 6 is a perspective view of an alternative embodiment of the instant invention wherein the wood splitting blade is slid along the beam; and

FIG. 7 is a perspective view of another alternative embodiment of the instant invention wherein the wood splitting blade is slid along the beam.

### DETAILED DESCRIPTION

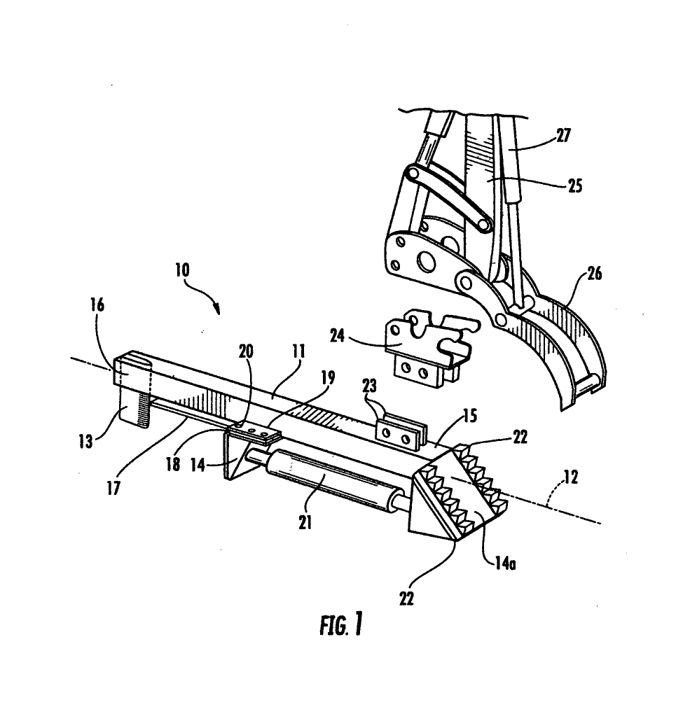

Referring now to FIG. 1, therein is shown a perspective view of a highly preferred apparatus 10 for positioning and splitting wood according to the instant invention. The apparatus 10 comprises a beam 11 having a first end 16 and a second end 15, the beam 11 having a longitudinal axis 12. The beam 11 is a steel box beam. A steel wood splitting blade 13 is welded to the first end 16 of the beam 11. A steel workpiece 14 is slidably attached to the beam 11 such that when wood is positioned between the splitting blade 13 and the workpiece 14 and the workpiece 14 is slid in the direction of the longitudinal axis 12 of the beam 11 toward the splitting blade 13, the wood is forced into the splitting blade 13 by hydraulic ram 21 to split the wood. A steel flange 17 is welded to both sides of the beam 11. A steel spacer 18 which is slightly thicker than the flange 17 is held in place on each side of the beam 11 by top plate 19 and bolts 20. A stationary jaw member in the form of a steel wedge 14a is welded to the second end 15 of the beam 11. The steel wedge 14a comprises steel toothed extensions 22 welded thereto. Perforated steel flanges 23 are welded near the second end 15 of the beam 11.

The apparatus 10 is to be attached to the boom of a backhoe or an excavator in place of the bucket thereof (or to the boom of a log loader). FIG. 1 shows the bucket end of a boom 25 of an excavator positioned over a quick coupler 24 which is, in turn positioned over the apparatus 10. In use, the apparatus 10 is bolted to the quick coupler 24 which is then coupled to the boom 25 in the conventional manner. The boom 25 is equipped with a jaw member 26 attached to the boom 25. The jaw member 26 is pivoted by hydraulic ram 27.

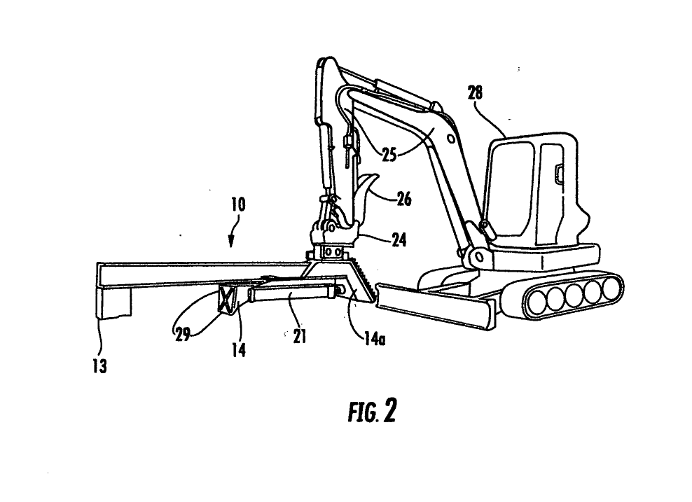

Referring now to FIG. 2, therein is shown a perspective view of the apparatus 10 attached to the boom 25 of an excavator 28 in place of the bucket of the excavator. In use, wood can be grasped between the stationary jaw member 14a and the movable jaw member 26 so that split or unsplit wood can be positioned by movement of the apparatus 10. As stated above, when wood is positioned between the splitting blade 13 and the workpiece 14 and the workpiece 14 is slid in the direction of the longitudinal axis of the beam 11 toward the splitting blade 13, the wood is forced into the splitting blade 13 by hydraulic ram 21 to split the wood. Preferably, the face of the workpiece 14 is ridged by welding ridges 29 thereto to provide a better grip between the wood and the workpiece 14.

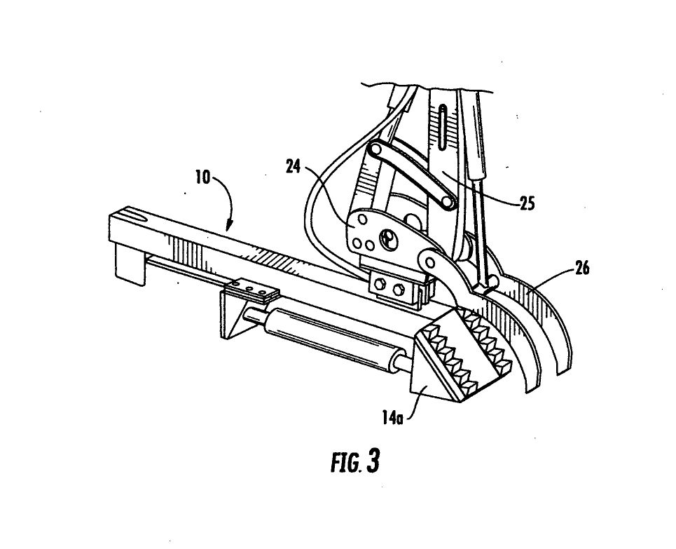

Referring now to FIG. 3, therein is shown a perspective view of a broken away portion of the bucket end of the boom 25 of the excavator 28 of FIG. 2 attached to a quick coupler 24 which is attached to the preferred apparatus 10 of the instant invention. Although the stationary jaw member 14a is wedge shaped in the preferred embodiment shown in FIG. 3, it should be understood that any suitable shape of jaw can be used such as the concave shape of the moveable jaw 26.

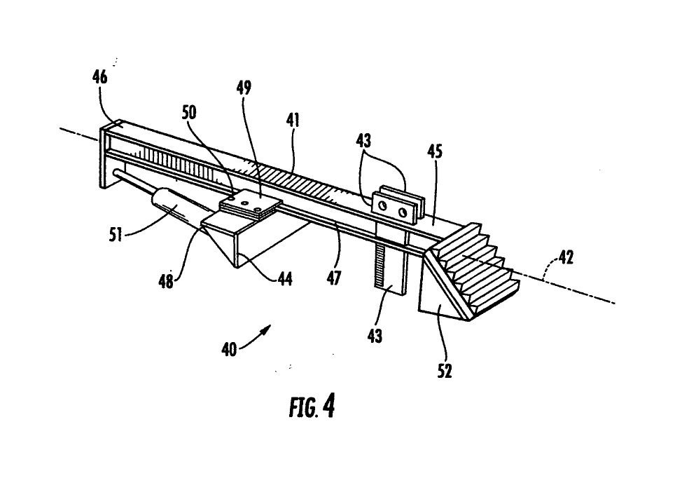

Referring now to FIG. 4, therein is shown a perspective view of an alternative apparatus 40 for positioning and splitting wood according to the instant invention. The apparatus 40 comprises an beam 41 having a first end 46 and a second end 45, the beam 41 having a longitudinal axis 42. The beam 41 is a steel I-beam. A steel wood splitting blade 43 is welded near the second end 45 of the beam 41. A steel workpiece 44 is slidably attached to the beam 41 such that when wood is positioned between the splitting blade 43 and the workpiece 44 and the workpiece 44 is slid in the direction of the longitudinal axis 42 of the beam 41 toward the splitting blade 43, the wood is forced into the splitting blade 43 by hydraulic ram 51 to split the wood. The beam 41 comprises a flange 47. A steel spacer 48 which is slightly thicker than the flange 47 is held in place on each side of the beam 41 by top plate 49 and bolts 50. A stationary jaw member in the form of a steel wedge 52 is welded to the first end 45 of the beam 41. Perforated steel flanges 43 are welded near the second end 45 of the beam 41 adapted for attachment to a quick coupler.

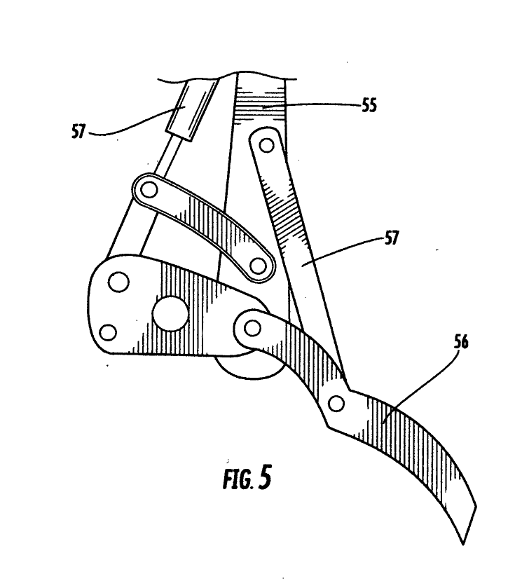

Referring now to FIG. 5, therein is shown a side broken away view of the lower end of the boom 55 of an excavator having a stationary jaw member 56 attached at one there of to the boom 55 and held in a stationary position by struts 57. When the apparatus of the instant invention is attached to the boom 55, wood can be grasped between the stationary jaw member of the apparatus of the instant invention and the stationary jaw 56 by actuation of the bucket hydraulic ram. However, it should be understood that employment of the movable jaw member 26 shown in FIG. 1 is preferable in the practice of the instant invention.

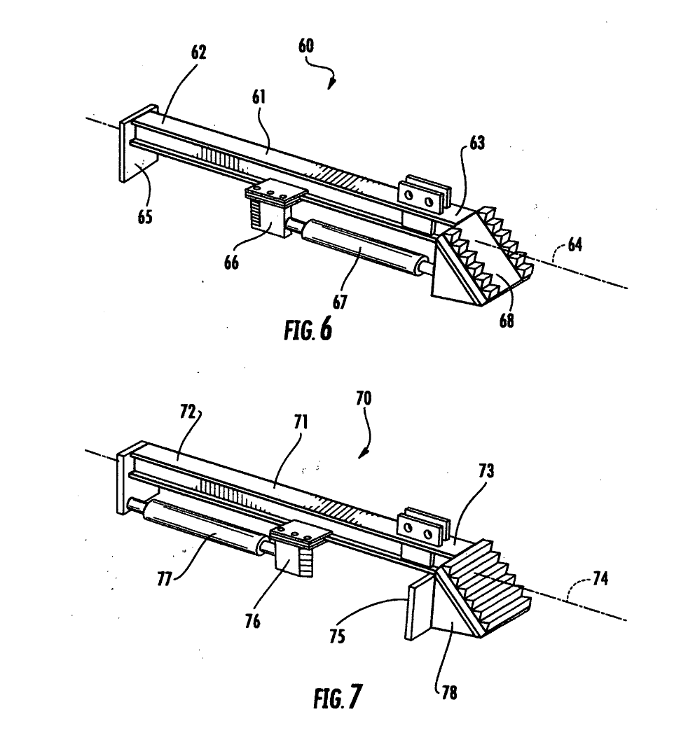

Referring now to FIG. 6, therein is shown an alternative apparatus 60 (preferably made of welded steel components) for positioning and splitting wood according to the instant invention. The apparatus 60 comprises a beam 61 having a first end 62 and a second end 63, the beam 61 having a longitudinal axis 64. A wood support 65 is attached at or near the first end 62 of the beam 61. A wood splitting blade 66 is slidably attached to the beam 61 such that when wood is positioned between the splitting blade 61 and the wood support 65 and the wood splitting blade 66 is slid in the direction of the longitudinal axis of the beam toward the wood support 65 by hydraulic ram 67, the wood splitting blade 66 is forced into the wood to split the wood. A stationary jaw member 68 is attached at or near the second end 63 of the beam 61 so that when the apparatus 60 is attached to the boom of a backhoe or excavator in place of the bucket thereof, wood can be grasped between the stationary jaw member 68 and a jaw member attached to the boom of the backhoe or excavator so that the wood can be positioned by movement of the apparatus.

Referring now to FIG. 7, therein is shown another alternative apparatus 70 (preferably made of welded steel components) for positioning and splitting wood according to the instant invention. The apparatus 70 comprises a beam 71 having a first end 72 and a second end 73, the beam 71 having a longitudinal axis 74. A wood support 75 is attached at or near the second end 73 of the beam 71. A wood splitting blade 76 is slidably attached to the beam 71 such that when wood is positioned between the splitting blade 71 and the wood support 75 and the wood splitting blade 76 is slid in the direction of the longitudinal axis of the beam toward the wood support 75 by hydraulic ram 77, the wood splitting blade 76 is forced into the wood to split the wood. A stationary jaw member 78 is attached at or near the second end 73 of the beam 71 so that when the apparatus 70 is attached to the boom of a backhoe or excavator in place of the bucket thereof, wood can be grasped between the stationary jaw member 78 and a jaw member attached to the boom of the backhoe or excavator so that the wood can be positioned by movement of the apparatus.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

What is claimed is:

1. Apparatus for positioning and splitting wood, comprising: a beam having a first end and a second end, the beam having a longitudinal axis; a wood splitting blade attached at or near the first end of the beam; a workpiece slidably attached to the beam such that when wood is positioned between the splitting blade and the workpiece and the workpiece is slid in the direction of the longitudinal axis of the beam toward the splitting blade, the wood is forced into the splitting blade to split the wood; and a stationary jaw member attached at or near the second end of the beam so that when the apparatus is attached to the boom of a backhoe or excavator in place of the bucket thereof, wood can be grasped between the stationary jaw member and a jaw member attached to the boom of the backhoe or excavator so that the wood can be positioned by movement of the apparatus.

2. The apparatus of claim 1, wherein the stationary jaw member is a wedge attached to the second end of the beam.

3. The apparatus of claim 1, further comprising a hydraulic ram attached at one end thereof at or near the second end of the beam and at the other end thereof to the workpiece.

4. The apparatus of claim 2, further comprising a hydraulic ram attached at one end thereof to the wedge and at the other end thereof to the workpiece.

5. The apparatus of claim 1, wherein the beam is a box beam.

6. The apparatus of claim 2, wherein the beam is a box beam.

7. The apparatus of claim 3, wherein the beam is a box beam.

8. The apparatus of claim 4, wherein the beam is a box beam.

9. The apparatus of claim 1, wherein the beam is an I-beam.

10. The apparatus of claim 4, wherein the beam is an I-beam.

11. Apparatus for positioning and splitting wood, comprising: a beam having a first end and a second end, the beam having a longitudinal axis; a wood splitting blade attached at or near the second end of the beam; a workpiece slidably attached to the beam such that when wood is positioned between the splitting blade and the workpiece and the workpiece is slid in the direction of the longitudinal axis of the beam toward the splitting blade, the wood is forced into the splitting blade to split the wood; and a stationary jaw member attached at or near the second end of the beam so that when the apparatus is attached to the boom of a backhoe or excavator in place of the bucket thereof, wood can be grasped between the stationary jaw member and a jaw member attached to the boom of the backhoe or excavator so that the wood can be positioned by movement of the apparatus.

12. The apparatus of claim 11, wherein the stationary jaw member is a wedge attached to the second end of the beam.

13. The apparatus of claim 11, further comprising a hydraulic ram attached at one end thereof at or near the first end of the beam and at the other end thereof to the workpiece.

14. The apparatus of claim 11, wherein the beam is a box beam.

15. The apparatus of claim 12, wherein the beam is a box beam.

16. The apparatus of claim 13, wherein the beam is a box beam.

17. The apparatus of claim 11, wherein the beam is an I-beam.

18. The apparatus of claim 12, wherein the beam is an I-beam.

19. The apparatus of claim 13, wherein the beam is an I-beam.

20. Apparatus for positioning and splitting wood, comprising: a beam having a first end and a second end, the beam having a longitudinal axis; a wood support attached at or near the first end of the beam; a wood splitting blade slidably attached to the beam such that when wood is positioned between the splitting blade and the wood support and the wood splitting blade is slid in the direction of the longitudinal axis of the beam toward the wood support, the splitting blade is forced into the wood to split the wood; and a stationary jaw member attached at or near the second end of the beam so that when the apparatus is attached to the boom of a backhoe or excavator in place of the bucket thereof, wood can be grasped between the stationary jaw member and a jaw member attached to the boom of the backhoe or excavator so that the wood can be positioned by movement of the apparatus.

21. Apparatus for positioning and splitting wood, comprising: a beam having a first end and a second end, the beam having a longitudinal axis; a wood support attached at or near the second end of the beam; a wood splitting blade slidably attached to the beam such that when wood is positioned between the wood support and the wood splitting blade and the wood splitting blade is slid in the direction of the longitudinal axis of the beam toward the wood support, the wood splitting blade is forced into the wood to split the wood; and a stationary jaw member attached at or near the second end of the beam so that when the apparatus is attached to the boom of a backhoe or excavator in place of the bucket thereof, wood can be grasped between the stationary jaw member and a jaw member attached to the boom of the backhoe or excavator so that the wood can be positioned by movement of the apparatus.
